(19) United States
(12) Patent Application Publication
(10) Pub. No.: US 2014/0246992 A1
(43) Pub. Date: Sep. 4, 2014

(54) PRIMARY SIDE CONTROL FOR SWITCH MODE POWER SUPPLIES

(71) Applicants: Satish Chandupatla, Woburn, MA (US); Ranjit Jayabalan, Danvers, MA (US)

(72) Inventors: Satish Chandupatla, Woburn, MA (US); Ranjit Jayabalan, Danvers, MA (US)

(73) Assignee: OSRAM SYLVANIA INC., Danvers, MA (US)

(21) Appl. No.: 14/196,985

(22) Filed: Mar. 4, 2014

Related U.S. Application Data
(60) Provisional application No. 61/772,483, filed on Mar. 4, 2013.

(51) Int. Cl. H05B 33/08; H02M 3/335

(52) U.S. Cl. CPC H05B 33/0815; H02M 3/33523
USPC 315/307; 363/21.16

(57) ABSTRACT

Techniques are disclosed for providing a stable output voltage in switching mode power supplies (SMPS). An SMPS includes a switching converter for powering a load, a passive startup circuit for initially providing an internal voltage supply for powering switching electronics when the mains is turned on, and a feedback circuit providing the internal voltage supply once the switching converter starts switching. The SMPS also includes a decoupling circuit that decouples or otherwise isolates the gain of the passive startup circuit from the feedback circuit, so as to prevent false dynamic overvoltage protection triggers. The decoupling circuit is implemented, for instance, with the addition of two or three passive components, such as a diode and a capacitor, or a diode, a capacitor, and a resistor. Preventing false triggering of the dynamic overvoltage protection in turn provides a more stable output voltage from the SMPS.

### CROSS-REFERENCE TO RELATED APPLICATION

The present application claims priority of U.S. Provisional Application No. 61/772,483, entitled “IMPROVED PRIMARY SIDE CONTROL IN FLYBACK CONVERTER FOR POWER SUPPLY” and filed Mar. 4, 2013, the entire contents of which are hereby incorporated by reference.

### TECHNICAL FIELD

The present invention relates to power supplies, and more particularly, to switch mode power supplies (SMPS) configured to provide both an output voltage suitable for a given load and an internal regulated power supply.

### BACKGROUND

A typical switch mode power supply (also called an SMPS) is a power supply that includes a switching regulator to efficiently convert electrical power. In particular, and like other power supply types, an SMPS receives power from a source, such as mains power, and converts that power to have certain voltage and current characteristics. The output voltage resulting from that conversion is then applied to a load (e.g., lighting elements, equipment, etc). Some SMPS configurations also call for an internal supply voltage to power the electronics of the SMPS, such as the switching control circuitry. This switching control circuitry is typically implemented with an integrated circuit (IC), such as a PFC controller. The internal supply voltage, which is sometimes referred to as an auxiliary voltage or VCC, is derived from the mains power using passive or active circuitry, which is generally referred to as the SMPS's startup circuitry. The SMPS may also be configured to regulate this internal voltage produced by the startup circuitry. Thus, an SMPS may be configured to provide a first regulated voltage (the output voltage) to a given load and a second regulated voltage (VCC) to internal circuitry of the SMPS.

### SUMMARY

As noted above, a switch mode power supply (SMPS) may be configured to provide both an output voltage to a given load as well as an internal voltage supply for internal electronics, such as but not limited to internal switching control circuitry. The output voltage for the load is typically generated by a converter, such as an AC-DC flyback converter, and the internal voltage supply is typically generated by a so-called startup circuit. With passive start-up circuits, however, the converter output voltage that drives the load can become unstable at a high AC mains voltage during light load conditions. Under such conditions, the additional gain provided by the startup circuit appears as an over voltage, which triggers dynamic over voltage protection (OVP) circuitry that is also present in the SMPS. When this occurs, the SMPS stops switching and then restarts when the internal gate drive is enabled. This stop-start behavior repeats until the light load condition clears.

Embodiments are disclosed that provide a stable output voltage in switching mode power supplies. In some embodiments, an SMPS is provided that includes a converter section for powering a load, a passive startup circuit for initially providing an internal voltage supply for powering the switching electronics of the SMPS when the mains is turned on, and a feedback circuit providing the internal voltage supply once the converter starts switching. The SMPS further includes a decoupling circuit that decouples the gain of the passive startup circuit from the feedback circuit, so as to prevent false dynamic OVP triggers. In some embodiments, the SMPS circuit is implemented with a flyback converter topology that is powered by a rectified AC line voltage. Of course, other SMPS topologies may be, and in some embodiments are, used as well, such as buck, boost, and buck-boost, as will be appreciated in light of this disclosure. The decoupling circuit is implemented, for example, with the addition of two or three passive components, such as but not limited to a diode and a capacitor, or a diode, a capacitor, and a resistor. Preventing false triggering of the dynamic OVP in turn provides a more stable output voltage. Numerous other embodiments and variations will be apparent in light of this disclosure.

In an embodiment, there is provided a power supply circuit. The power supply circuit includes: a controller; a switching converter comprising a transformer and a switch configured to be controlled by the controller, the switching converter configured to receive voltage from a voltage source and to provide an output voltage suitable to drive a load; a startup circuit having a gain and configured to receive voltage from the voltage source and to provide a startup voltage to the controller; a feedback circuit configured to provide a feedback voltage to the controller, the feedback voltage based on the output voltage of the converter; and a decoupling circuit operatively coupled to the feedback circuit and configured to isolate the feedback voltage from the gain of the startup circuit.

In a related embodiment, the transformer may include a three-winding transformer having a primary side winding, a secondary side winding, and a primary side bias winding, and the primary side bias winding may be part of the feedback circuit. In another related embodiment, the transformer may include a three-winding transformer having a primary side winding, a secondary side winding, and a primary side bias winding, and the primary side bias winding may be operably coupled to the feedback circuit.

In still another related embodiment, the controller may include overvoltage protection (OVP) circuitry that triggers in response to the feedback voltage being higher than a defined upper limit. In yet another related embodiment, the switching converter may be a flyback converter. In still yet another related embodiment, the startup circuit may be passive and may include a resistor connected in series with a capacitor. In a further related embodiment, the passive startup circuit and the switching converter may be configured to receive a rectified AC line voltage.

In another embodiment, there is provided a lighting system. The lighting system includes: a solid state lighting element; a switching converter comprising a transformer and a switch configured to be controlled by a control signal, the converter configured to receive voltage from a voltage source and to provide an output voltage suitable to drive the solid state lighting element; a controller configured to provide the control signal and comprising overvoltage protection (OVP) circuitry that triggers in response to a feedback voltage being higher than a defined upper limit, wherein the feedback voltage is based on the output voltage of the switching converter; a startup circuit having a gain and configured to receive voltage from the voltage source and to provide a startup voltage to the controller; a feedback circuit configured to provide the feedback voltage to the controller; and a decoupling circuit operatively coupled to the feedback circuit and configured to isolate the feedback voltage from the gain of the startup circuit.

In a related embodiment, the transformer may be a three-winding transformer including a primary side winding, a secondary side winding, and a primary side bias winding, and the primary side bias winding may be part of the feedback circuit. In another related embodiment, the transformer may be a three-winding transformer including a primary side winding, a secondary side winding, and a primary side bias winding, and the primary side bias winding may be operably coupled to the feedback circuit.

In still another related embodiment, the switching converter may be a flyback converter. In yet another related embodiment, the startup circuit may be passive and may include a resistor connected in series with a capacitor. In still yet another related embodiment, the lighting system may further include a rectifier configured to provide rectified AC voltage to the startup circuit and to the switching converter.

In another embodiment, there is provided a method. The method includes: providing, via a switching converter including a transformer and a switch configured to be controlled by a control signal, an output voltage suitable to drive a load; providing, via controller circuitry, the control signal; providing, via a startup circuit having a gain, a startup voltage to the controller circuitry; providing, via a feedback circuit, a feedback voltage to the controller circuitry, the feedback voltage based on the output voltage of the converter; and isolating, via a decoupling circuit, the feedback voltage from the gain of the startup circuit so as to prevent overvoltage protection (OVP) circuitry from falsely triggering.

In a related embodiment, the method may further include: rectifying an input AC voltage; and providing the rectified input AC voltage to the startup circuit and to the switching converter. In another related embodiment, the method may further include: processing an input voltage; and providing the processed input voltage to the startup circuit and to the switching converter.

In still another related embodiment, providing, via a switching converter including a transformer and a switch configured to be controlled by a control signal, an output voltage includes providing, via a switching converter including a transformer and a switch configured to be controlled by a control signal, an output voltage suitable to drive a lighting element, and wherein the method reduces flickering of the lighting element due to false triggering of the OVP circuitry. In yet another related embodiment, the method may further include triggering the OVP circuitry of the controller circuitry in response to a valid OVP condition.

### BRIEF DESCRIPTION OF THE DRAWINGS

The foregoing and other objects, features and advantages disclosed herein will be apparent from the following description of particular embodiments disclosed herein, as illustrated in the accompanying drawings in which like reference characters refer to the same parts throughout the different views. The drawings are not necessarily to scale, emphasis instead being placed upon illustrating the principles disclosed herein.

FIG. 1 schematically illustrates a flyback converter-based power supply system that may become unstable under certain conditions, according to embodiments disclosed herein.

FIG. 2 illustrates a block diagram of a power supply system configured with the overvoltage protection circuitry decoupled from the gain of the startup circuit, according to embodiments disclosed herein.

FIG. 3 schematically illustrates a power supply circuit with the overvoltage protection circuitry decoupled from the gain of the startup circuit, according to embodiments disclosed herein.

FIG. 4 schematically illustrates a power supply circuit with the overvoltage protection circuitry decoupled from the gain of the startup circuit, according to embodiments disclosed herein.

### DETAILED DESCRIPTION

As discussed above, the output voltage of a switching converter-based power supply circuit may become unstable when there is a high AC mains input voltage, particularly during light load conditions. Such power supply circuits may be, for example, a flyback converter-based power supply for use in solid state lighting applications, although various SMPS topologies and applications will be apparent in light of this disclosure. To further explain the stability problem, it may first be helpful to understand an example scenario where the instability may manifest. In more detail, a typical SMPS needs an internal supply voltage at startup equal to the turn-on threshold voltage of the controller IC used to control the converter's transistor (switching element). In some cases, this startup voltage may be supplied by a passive startup circuit. After startup, the SMPS may use a primary side auxiliary or bias winding connected to the flyback converter to provide VCC to the controller. The primary side bias winding may also provide output voltage regulation. In universal mains applications, a combination of high line voltage, light load conditions, and the additional gain provided by the passive startup circuit may decrease output voltage regulation, in some cases. The additional gain from the startup circuit may cause false triggering of dynamic OVP within the controller IC and limit the effectiveness of the SMPS when operated in wide load range applications. This is because false triggering of OVP causes the controller IC to temporarily stop switching the flyback converter transistor, which in turn causes the flyback output voltage and the internal supply voltage for the controller IC to be unstable. This instability may manifest in a number of ways, depending on the application. For example, in a lighting application, the instability may cause flickering of the lighting element, while in a communication application, the instability may cause messaging errors. An active startup circuit may be used, which may not cause the instability, but involves active componentry and the cost associated therewith. In addition, depending on the design of the active startup circuit, there may still be an additional gain that causes false OVP triggering thereby giving rise to the stability problem. In a lighting application, a light load condition may occur, for instance, when solid state lighting elements are used rather than incandescent or fluorescent lighting elements.

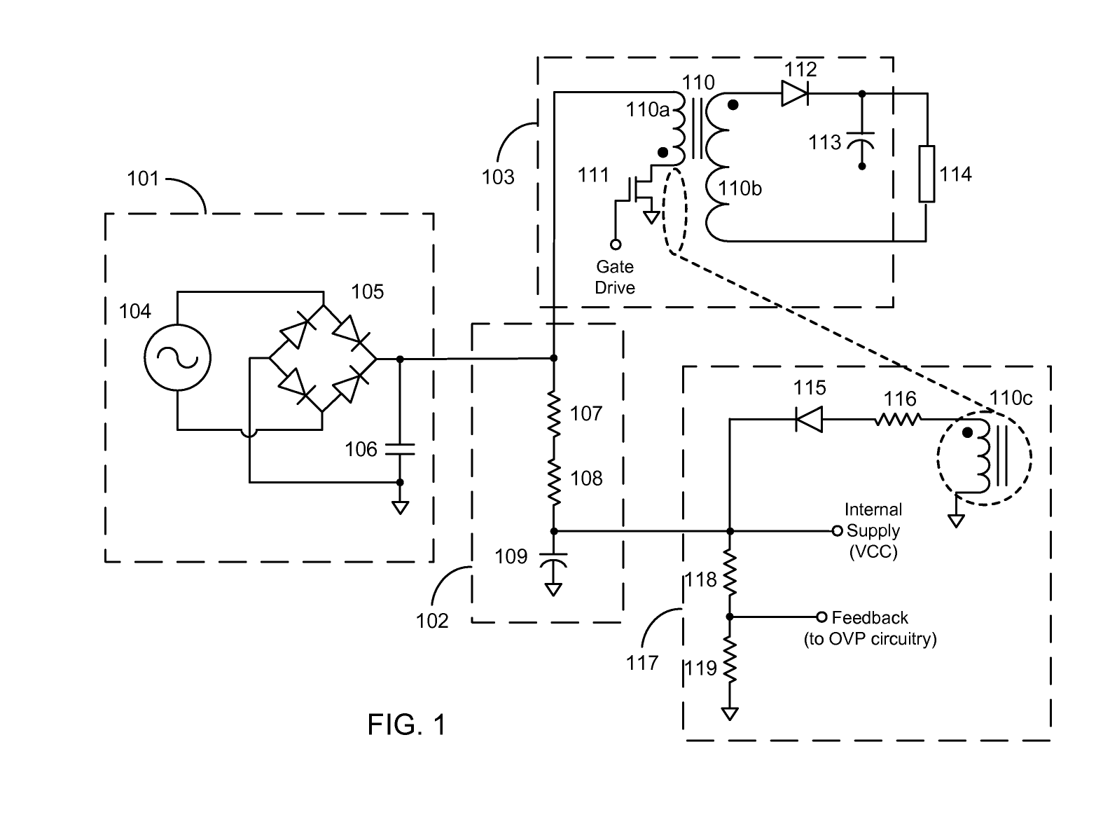

FIG. 1 schematically illustrates an SMPS configured with a rectified voltage source 101, a flyback converter 103, a passive startup circuit 102, and a feedback circuit 117. The rectified voltage source 101 includes an AC voltage source 104, a diode bridge rectifier 105, and a capacitor 106. The diode bridge rectifier is connected across the AC voltage source 104, and the capacitor 106 is connected to the output of the diode bridge rectifier 105. This creates a rectified AC voltage from the AC voltage source 104, which is provided to the flyback converter 103. The flyback converter 103 includes a three-winding flyback transformer 110, having a primary side winding 110a, a secondary side winding 110b, and a primary side bias winding 110c, a switching transistor 111, a diode 112, and a capacitor 113. A load 114 is coupled to the output of the SMPS, that is, across the secondary side winding 110b. The primary side winding 110a is connected to the output of the rectified voltage source 101 and thus receives the rectified AC voltage. The diode 112 is connected between the secondary side winding 110b and the load 114, and the capacitor is connected between the diode 112 and the load 114. The switching transistor 111 includes a gate, a source, and a drain. The gate is connected to a gate drive input from a controller, as described below, the source is connected to the primary side winding 110a, and the drain is connected to a ground. In FIG. 1, the windings of the flyback transformer 110 are all coupled but have different polarities. Specifically, the secondary side winding 110b and the primary side bias winding 110c have the same polarity, and the primary side winding 110a has the opposite polarity. In addition, the primary side bias winding 110c and the secondary side winding 110b have a different number of turns, so the voltage on the primary side bias winding 110c is proportional to the voltage on the secondary side winding 110b. The voltage on the primary side bias winding 110c reflects the voltage on the secondary side winding 110b with a scaling factor of the number of turns on the primary side bias winding 110c divided by the number of turns on the secondary side winding 110b. This is determined by dividing the voltage on primary side bias winding 110c by the voltage on the secondary side winding 110b. In some embodiments, the load 114 is one or more solid state lighting elements, such as but not limited to one or more light emitting diodes, organic light emitting diodes (OLEDs), polymer light emitting diodes (PLEDs), organic light emitting compounds (OLECs), combinations thereof, and/or devices including the same, and in other embodiments, the load 114 is any load that provides a light load condition.

The rectified AC voltage is also output to the passive startup circuit 102, which includes a first resistor 107, a second resistor 108, and a polarized capacitor 109. The first resistor 107, the second resistor 108, and the polarized capacitor 109 are in series with each other. The first resistor 107 and the second resistor 108 are in series between the rectified voltage source 101 and the feedback circuit 117. The polarized capacitor 109 is also connected to a ground. The feedback circuit 117 is connected between the second resistor 108 and the polarized capacitor 109. The feedback circuit 117 includes the primary side bias winding 110c, which provides the internal voltage supply (VCC) to a controller or control IC (not shown in FIG. 1) through a third resistor 116 and a diode 115, which are in series with each other between an input to the feedback circuit 117 and the primary side bias winding 110c. The primary side bias winding 110c also provides a feedback voltage to the controller through a resistive divider formed by the series connection between a fourth resistor 118 and a fifth resistor 119. The controller, which in some embodiments is implemented with any suitable control circuitry, such as but not limited to a control IC or discrete components or some combination thereof, and includes dynamic OVP circuitry that triggers in response to a feedback signal. The feedback signal may be, and in some embodiments is, received directly by the OVP circuitry, and in some embodiments is received indirectly, such as but not limited to via an error amplifier or other intervening circuitry. In some embodiments, the controller is implemented with an L6562 or L6563 integrated circuit, both of which are commercially available PFC controllers produced by STMicroelectronics, although other comparable such ICs or controller circuits may be used.

The passive startup circuit 102 initially provides the internal supply voltage VCC for the controller when the AC mains are turned on, and in turn the gate drive of the controller operates the switching transistor 111. Once the flyback converter 103 starts switching, the primary side bias winding 110c provides VCC to the controller. As previously explained, the voltage on the primary side bias winding 110c reflects the secondary side voltage of the transformer 110 and also provides output voltage regulation. At high voltage values of the AC source 104, the output voltage represented by the feedback voltage between the fourth resistor 118 and the fifth resistor 119 may become further increased due to the gain of the passive startup circuit 102. This increase in the feedback voltage may trigger the dynamic OVP circuitry within the controller, thereby causing the controller to temporarily stop the switching transistor 111. This stop-and-start switching effect is an instability that may manifest in the load 114 (e.g., flickering light, etc). In controllers without dynamic OVP protection, the additional gain provided by the passive startup circuit 102 will result in increased signal level or gain higher than the internal controller reference, resulting in instability and loss of regulation of the output current/voltage. For example, at high input AC voltage, the additional gain may cause the output voltage/current to decrease from the nominal voltage/current due to added input signal from the startup circuit 102 to the feedback pin of the control IC. This in turn limits the design of very wide input voltage range converters (e.g., such as in the example case of 108 to 305VAC), especially when there is no DC-DC converter as a second stage supplying the load.

Thus, embodiments provide a stable output voltage by isolating the output voltage feedback loop (i.e., the feedback circuit 117) from the gain provided by the passive startup circuit 102. Decoupling the output voltage feedback from the passive startup circuit 102 inhibits false triggering of dynamic OVP, thus increasing the stability of the output voltage throughout a wide load range suitable for universal mains operation. In addition, decoupling of output voltage feedback from the passive startup circuit 102 prevents output current instability/loss of regulation, thus improving stable and regulated operation throughout wide input voltage range suitable for the desired load 114. Note that this result, in some embodiments, is achieved without an active startup circuit, which in turn decreases active component count, circuit complexity, power consumption, and cost.

Though lighting circuits having various converter types may benefit from isolating the output voltage feedback or control loop pin of a control IC from the startup circuit, for ease of description, embodiments are described with flyback converters including a primary side bias winding that provides a reflection of the secondary side of the flyback converter transformer. As will be appreciated, embodiments may also be, and sometimes are, implemented with a DC voltage source. In such embodiments, a wide operating range of DC source may cause problems with output voltage stability similar to a rectified AC source, and the techniques described herein may be implemented to stabilize the output voltage.

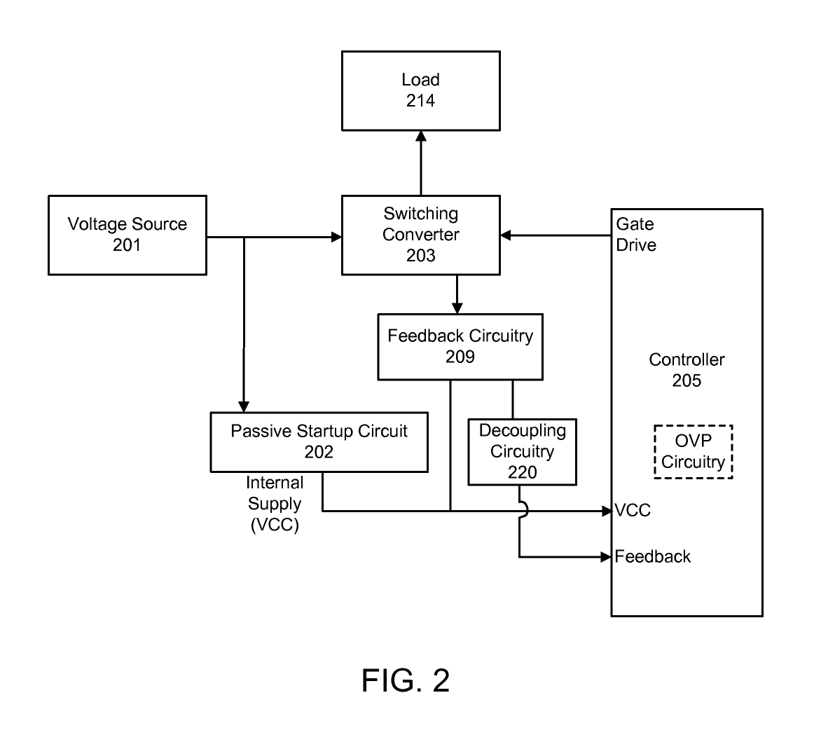

FIG. 2 illustrates a block diagram of a power supply system configured with the overvoltage protection circuitry decoupled from the gain of the startup circuit. In FIG. 2, the system includes a voltage source 201 that feeds a switching converter 203 and a passive startup circuit 202. In some embodiments, the voltage source 201 includes an AC source and a rectifier (as shown in FIG. 1) configured to provide a rectified AC line voltage to the switching converter 203 and the passive startup circuit 202, while in other embodiments the voltage source 201 is a DC voltage source. At startup, the passive startup circuit 202 provides VCC (or the turn-on threshold voltage) to the controller 205. A gate drive output of the controller 205 controls a switching transistor (not shown in FIG. 2) of the switching converter 203. Once the switching converter 203 starts switching, the feedback circuitry 209, including the primary side bias winding as shown in FIG. 1, provides VCC to the controller 205. Decoupling circuitry 220, however, isolates the passive startup circuit 202 from a feedback input of the controller 205, which is the controller input that provides a basis for an OVP condition. In FIG. 2, the switching converter 203 is controlled by the gate drive output of the controller 205 and provides power to a load 214. The load 214 is, in some embodiments, one or more solid state lighting elements. Alternatively, the load 214 is any other circuit or electronic element powered by the power supply system, and the techniques described herein are not intended to be limited to any particular type of power-consuming element. As discussed above, the controller 205 in some embodiments includes an active startup circuit, such as the L6563 IC, and is thus used to control the switching converter 203 of the power supply system. However, as will be appreciated, the techniques described herein allow for a simpler and more cost effective controller (e.g., an internal active startup circuit is not needed). An example of one such controller is the L6562 IC.

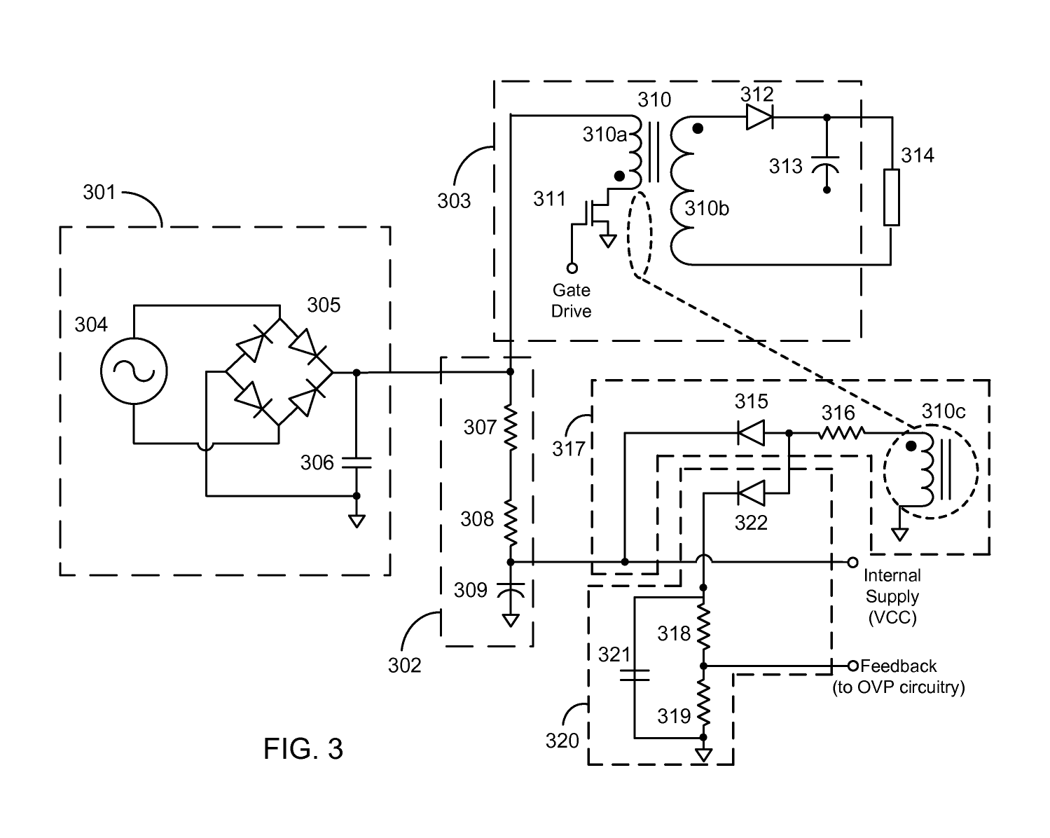

FIG. 3 illustrates a switching mode power supply configured with overvoltage protection circuitry decoupled from the gain of the startup circuit. The SMPS of FIG. 3 includes a rectified voltage source 301, a flyback converter 303, a passive startup circuit 302, a feedback circuit 317, and a decoupling circuit 320. The rectified voltage source 301 includes an AC voltage source 304, a diode bridge rectifier 305, and a capacitor 306, configured similarly to the rectified voltage source 101 of FIG. 1. The rectified voltage source 301 provides a rectified AC voltage to the passive startup circuit 302, which includes a first resistor 307, a second resistor 308, and a polarized capacitor 309, and is also configured similarly to the passive startup circuit 102 of FIG. 1. The rectified AC voltage is also provided to the flyback converter 303, which includes a three-winding transformer 310 having a primary side winding 310, a secondary side winding 310b, and a primary side bias winding 310c, and is configured similarly to the transformer 110 of FIG. 1. The flyback converter 303 also includes a switching transistor 311, having a gate, a source, and a drain, a diode 312, and a capacitor 313, also configured similarly to the flyback converter 103 of FIG. 1. A load 314 is driven the by output voltage of the flyback converter 303.

In FIG. 3, the feedback circuit 317 includes the primary side bias winding 310c that reflects the voltage of the secondary side winding 310b of the flyback converter 303, and provides the internal voltage supply (VCC) to a controller or control IC (not shown in FIG. 3) through a third resistor 316 and a diode 315, after startup, once the flyback converter 303 starts switching. The feedback circuit 317 is configured similarly to the feedback circuit 117 of FIG. 1, though without a fourth resistor and a fifth resistor. The decoupling circuit 320 is operatively connected with the feedback circuit 317 between the third resistor 316 and the diode 315, and includes a diode 322, a fourth resistor 318, a fifth resistor 319, and a capacitor 321. The diode 322 is connected between the third resistor 316 and the diode 315, the fourth resistor 318 and the fifth resistor 319 are in series as a resistive divider, and the capacitor 321 is in parallel across the fourth resistor 318 and the fifth resistor 319. The decoupling circuit 320 effectively decouples the feedback voltage from the additional gain of the passive startup circuit 302, and provides that feedback voltage to the control IC through the resistive divider of the fourth resistor 318 and the fifth resistor 319.

The controller (not shown in FIG. 3) is implemented with any suitable control circuitry (whether implemented with a controller IC or discrete components or some combination thereof), that may or may not include dynamic OVP circuitry. In some embodiments, the controller is implemented with an L6562 integrated circuit, wherein the VCC output of the passive startup circuit 302 is connected to pin 8 of the L6562, the feedback voltage output of the decoupling circuitry 320 is connected to pin 1 of the L6562, and the switching transistor 311 of the flyback converter 303 is controlled by pin 7 (the gate drive) of the L6562 IC. As previously discussed, the gain of the passive startup circuit 302 may affect the output voltage feedback signal value and cause a false triggering of dynamic OVP in the controller, especially at high input voltage values (AC mains) and low load conditions. The decoupling circuitry 320 operates to decouple or otherwise isolate the output voltage feedback signal from the passive startup circuit 302. The feedback loop also isolates the output voltage from fluctuations in the rectified AC line voltage. This isolation stabilizes the output voltage feedback to the controller and prevents false triggering of OVP and improves load regulation, which in turn provides stability to the flyback converter 303.

As will be appreciated, the designations as to what is included in the feedback circuit 317 and the decoupling circuit 320 are provided for purposes of discussion and are not intended to implicate limitations as to a particular structure or circuit. In some embodiments, each of the feedback circuit 317 and the decoupling circuit 320 may effectively include the primary side bias winding 310c as well as the third resistor 316, though this is not shown in FIG. 3. Numerous other such variations will be apparent in light of this disclosure.

In embodiments wherein the load 314 includes one or more solid state lighting elements, which may operate at lower load conditions compared to incandescent, fluorescent, or other lighting systems, periodic high voltages from the rectified AC voltage source 301 combined with gain from the passive startup circuit 302 may trigger OVP at the controller if the output voltage feedback is not isolated from the passive startup circuit 302. Triggering OVP causes the gate drive of the controller to stop switching the switching transistor 311 of the flyback converter 303 and thus creates flickering in the lighting load 314. Thus, the circuit shown in FIG. 3 may be used to provide power for a flicker-free lighting system capable of operating at a wide load range suitable for AC mains applications.

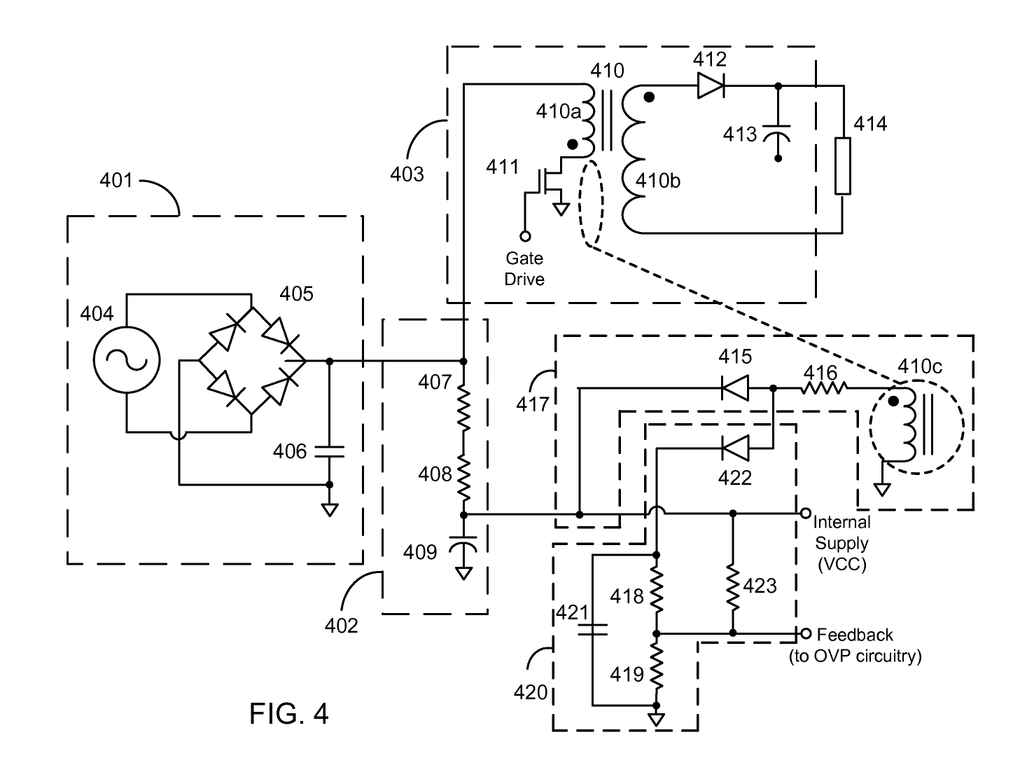

FIG. 4 illustrates a power supply circuit with the overvoltage protection circuitry decoupled from the gain of the startup circuit. The circuit of FIG. 4 is similar to the one described in reference to FIG. 3, and includes a rectified voltage source 401, a passive startup circuit 402, a flyback converter 403, a feedback circuit 417, and a decoupling circuit 420. The rectified voltage source 401 includes an AC voltage source 404, a diode bridge rectifier 405, and a capacitor 406 configured in the same way as the rectified voltage source 301 of FIG. 3. The rectified AC voltage is output to the passive startup circuit 402, which includes a first resistor 407, a second resistor 408, and a polarized capacitor 409, configured in the same way as the passive startup circuit 302 of FIG. 3. The rectified AC voltage is also output to the flyback converter 403, which includes a three-winding transformer 410 having a primary side winding 410a, a secondary side winding 410b, and a primary side bias winding 410c, configured in a similar fashion as discussed with respect to the transformer 310 of FIG. 3), a switching transistor 411, a diode 412, and a capacitor 413, all configured in the same way as the flyback converter 303 of FIG. 3. A load 414 is driven the by output voltage of the flyback converter 403.

In FIG. 4, the feedback circuit 417 is configured similarly to the feedback circuit 317 and includes the primary side bias winding 410c, which reflects the voltage of the secondary side winding 410b of the flyback converter 403, and provides the internal voltage supply (VCC) to a controller or control IC (not shown in FIG. 4) through a third resistor 416 and a diode 415, after startup, once the flyback converter 403 starts switching. The decoupling circuit 420 is operatively connected with the feedback circuit 417 (between the third resistor 416 and the diode 415) and includes a diode 422, a fourth resistor 418, a fifth resistor 419, and a capacitor 421, all configured in the same way as the decoupling circuit 320 of FIG. 3. In addition, a sixth resistor 423 is provided between the VCC input of the controller and the feedback input of the controller within the decoupling circuit 420. The circuit effectively decouples the feedback voltage from the additional gain of the passive startup circuit 402, and provides that feedback voltage to the control IC through the resistive divider of the fourth resistor 418 and the fifth resistor 419. Depending on the controller, the sixth resistor 423 in some embodiments is used to enable the controller during startup. In some embodiments, the power supply circuit of FIG. 4 is connected to an L6562 IC controller, which has a disable function on pin 1 (which receives the output voltage feedback) and requires at least 0.45V on pin 1 to enable the IC. In such embodiments, the addition of the sixth resistor 423 is used to provide the required voltage at startup. In such embodiments, the gate of the switching transistor 411 is connected to pin 7 of the L6562 controller (the gate drive pin), and the output voltage feedback is connected to pin 8 of the L6562 controller. As will be appreciated, other embodiments include variations and/or additions to the power supply circuits shown in FIGS. 3-4 depending on factors such as the controller type or converter type.

As will be appreciated, the various values and particulars of the components change from one embodiment to the next, and will depend on the application at hand. In some embodiments, the circuits shown in FIGS. 1, 3, and 4 have the following values as indicated in Table 1:

TABLE 1
Example Components

| Component or Parameter | Value |
|---|---|
| Source 104/304/404 | 120 V-277 VAC |
| Diodes 105/305/405 | 800 V, 1 A |
| Capacitor 106/306/406 | 100 nF, 560 VDC |
| Switch 111/311/411 | 800 V, 5 A N-channel FET |
| Diode 112/312/412 | 400 V, 5 A ultrafast diode |
| Capacitor 113/313/413 | 1000 UF, Electrolytic Cap |
| Transformer 110/310/410 | 800 uH primary inductance, E20 |
| | core for a 20 W power level |
| Controller | L6562A |
| VCC | 12 V to 17 V (pin 8 of L6562A) |
| Feedback Voltage | 2.475 V to 2.525 V (pin 1 of L6562A) |
| Resistor 107/307/407 | 100KΩ to 150KΩ |
| Resistor 108/308/408 | 100KΩ to 150KΩ |
| Capacitor 109/309/409 | 22 μF to 33 μF |
| Resistor 118/318/418 | 13KΩ |
| Resistor 119/319/419 | 2KΩ |
| Resistor 116/316/416 | 47Ω |
| Diode 115/315/415 | 100 V, 150 mA |
| Capacitor 321/421 | 0.1 μF to 1 μF |
| Resistor 423 | 680KΩ |

A reasonable tolerance (e.g., +/−1% or +/−5%) should be presumed if no example range is given. Note that these example values and components are not intended to limit the claimed invention but are provided to show example configurations. As will be further appreciated, the size and/or value of a given component will depend on the power level and other pertinent factors that will reveal themselves for a given application. Numerous other configurations will be apparent in light of this disclosure.

The methods and systems described herein are not limited to a particular hardware or software configuration, and may find applicability in many computing or processing environments. The methods and systems may be implemented in hardware or software, or a combination of hardware and software. The methods and systems may be implemented in one or more computer programs, where a computer program may be understood to include one or more processor executable instructions. The computer program(s) may execute on one or more programmable processors, and may be stored on one or more storage medium readable by the processor (including volatile and non-volatile memory and/or storage elements), one or more input devices, and/or one or more output devices. The processor thus may access one or more input devices to obtain input data, and may access one or more output devices to communicate output data. The input and/or output devices may include one or more of the following: Random Access Memory (RAM), Redundant Array of Independent Disks (RAID), floppy drive, CD, DVD, magnetic disk, internal hard drive, external hard drive, memory stick, or other storage device capable of being accessed by a processor as provided herein, where such aforementioned examples are not exhaustive, and are for illustration and not limitation.

The computer program(s) may be implemented using one or more high level procedural or object-oriented programming languages to communicate with a computer system; however, the program(s) may be implemented in assembly or machine language, if desired. The language may be compiled or interpreted.

As provided herein, the processor(s) may thus be embedded in one or more devices that may be operated independently or together in a networked environment, where the network may include, for example, a Local Area Network (LAN), wide area network (WAN), and/or may include an intranet and/or the internet and/or another network. The network(s) may be wired or wireless or a combination thereof and may use one or more communications protocols to facilitate communications between the different processors. The processors may be configured for distributed processing and may utilize, in some embodiments, a client-server model as needed. Accordingly, the methods and systems may utilize multiple processors and/or processor devices, and the processor instructions may be divided amongst such single- or multiple-processor/devices.

The device(s) or computer systems that integrate with the processor(s) may include, for example, a personal computer(s), workstation(s) (e.g., Sun, HP), personal digital assistant(s) (PDA(s)), handheld device(s) such as cellular telephone(s) or smart cellphone(s), laptop(s), handheld computer(s), or another device(s) capable of being integrated with a processor(s) that may operate as provided herein. Accordingly, the devices provided herein are not exhaustive and are provided for illustration and not limitation.

References to “a microprocessor” and “a processor”, or “the microprocessor” and “the processor,” may be understood to include one or more microprocessors that may communicate in a stand-alone and/or a distributed environment(s), and may thus be configured to communicate via wired or wireless communications with other processors, where such one or more processor may be configured to operate on one or more processor-controlled devices that may be similar or different devices. Use of such “microprocessor” or “processor” terminology may thus also be understood to include a central processing unit, an arithmetic logic unit, an application-specific integrated circuit (IC), and/or a task engine, with such examples provided for illustration and not limitation.

Furthermore, references to memory, unless otherwise specified, may include one or more processor-readable and accessible memory elements and/or components that may be internal to the processor-controlled device, external to the processor-controlled device, and/or may be accessed via a wired or wireless network using a variety of communications protocols, and unless otherwise specified, may be arranged to include a combination of external and internal memory devices, where such memory may be contiguous and/or partitioned based on the application. Accordingly, references to a database may be understood to include one or more memory associations, where such references may include commercially available database products (e.g., SQL, Informix, Oracle) and also proprietary databases, and may also include other structures for associating memory such as links, queues, graphs, trees, with such structures provided for illustration and not limitation.

References to a network, unless provided otherwise, may include one or more intranets and/or the internet. References herein to microprocessor instructions or microprocessor-executable instructions, in accordance with the above, may be understood to include programmable hardware.

Unless otherwise stated, use of the word “substantially” may be construed to include a precise relationship, condition, arrangement, orientation, and/or other characteristic, and deviations thereof as understood by one of ordinary skill in the art, to the extent that such deviations do not materially affect the disclosed methods and systems.

Throughout the entirety of the present disclosure, use of the articles “a” and/or an and/or the to modify a noun may be understood to be used for convenience and to include one, or more than one, of the modified noun, unless otherwise specifically stated. The terms “comprising”, “including” and “having” are intended to be inclusive and mean that there may be additional elements other than the listed elements.

Elements, components, modules, and/or parts thereof that are described and/or otherwise portrayed through the figures to communicate with, be associated with, and/or be based on, something else, may be understood to so communicate, be associated with, and or be based on in a direct and/or indirect manner, unless otherwise stipulated herein.

Although the methods and systems have been described relative to a specific embodiment thereof, they are not so limited. Obviously many modifications and variations may become apparent in light of the above teachings. Many additional changes in the details, materials, and arrangement of parts, herein described and illustrated, may be made by those skilled in the art.

What is claimed is:

1. A power supply circuit comprising:
a controller;
a switching converter comprising a transformer and a switch configured to be controlled by the controller, the switching converter configured to receive voltage from a voltage source and to provide an output voltage suitable to drive a load;
a startup circuit having a gain and configured to receive voltage from the voltage source and to provide a startup voltage to the controller;
a feedback circuit configured to provide a feedback voltage to the controller, the feedback voltage based on the output voltage of the converter; and
a decoupling circuit operatively coupled to the feedback circuit and configured to isolate the feedback voltage from the gain of the startup circuit.

2. The power supply circuit of claim 1, wherein the transformer comprises a three-winding transformer having a primary side winding, a secondary side winding, and a primary side bias winding, and wherein the primary side bias winding is part of the feedback circuit.

3. The power supply circuit of claim 1, wherein the transformer comprises a three-winding transformer having a primary side winding, a secondary side winding, and a primary side bias winding, and wherein the primary side bias winding is operably coupled to the feedback circuit.

4. The power supply circuit of claim 1, wherein the controller includes overvoltage protection (OVP) circuitry that triggers in response to the feedback voltage being higher than a defined upper limit.

5. The power supply circuit of claim 1, wherein the switching converter is a flyback converter.

6. The power supply circuit of claim 1, wherein the startup circuit is passive and comprises a resistor connected in series with a capacitor.

7. The power supply circuit of claim 6, wherein the passive startup circuit and the switching converter are configured to receive a rectified AC line voltage.

8. A lighting system comprising:
a solid state lighting element;
a switching converter comprising a transformer and a switch configured to be controlled by a control signal, the converter configured to receive voltage from a voltage source and to provide an output voltage suitable to drive the solid state lighting element;
a controller configured to provide the control signal and comprising overvoltage protection (OVP) circuitry that triggers in response to a feedback voltage being higher than a defined upper limit, wherein the feedback voltage is based on the output voltage of the switching converter;
a startup circuit having a gain and configured to receive voltage from the voltage source and to provide a startup voltage to the controller;
a feedback circuit configured to provide the feedback voltage to the controller; and
a decoupling circuit operatively coupled to the feedback circuit and configured to isolate the feedback voltage from the gain of the startup circuit.

9. The lighting system of claim 8, wherein the transformer is a three-winding transformer comprising a primary side winding, a secondary side winding, and a primary side bias winding, and wherein the primary side bias winding is part of the feedback circuit.

10. The lighting system of claim 8, wherein the transformer is a three-winding transformer comprising a primary side winding, a secondary side winding, and a primary side bias winding, and wherein the primary side bias winding is operably coupled to the feedback circuit.

11. The lighting system of claim 8, wherein the switching converter is a flyback converter.

12. The lighting system of claim 8, wherein the startup circuit is passive and comprising a resistor connected in series with a capacitor.

13. The lighting system of claim 8, further comprising a rectifier configured to provide rectified AC voltage to the startup circuit and to the switching converter.

14. A method comprising:
providing, via a switching converter including a transformer and a switch configured to be controlled by a control signal, an output voltage suitable to drive a load;
providing, via controller circuitry, the control signal;
providing, via a startup circuit having a gain, a startup voltage to the controller circuitry;
providing, via a feedback circuit, a feedback voltage to the controller circuitry, the feedback voltage based on the output voltage of the converter; and
isolating, via a decoupling circuit, the feedback voltage from the gain of the startup circuit so as to prevent overvoltage protection (OVP) circuitry from falsely triggering.

15. The method of claim 14, further comprising:
rectifying an input AC voltage; and
providing the rectified input AC voltage to the startup circuit and to the switching converter.

16. The method of claim 14, further comprising:
processing an input voltage; and
providing the processed input voltage to the startup circuit and to the switching converter.

17. The method of claim 14, wherein providing, via a switching converter including a transformer and a switch configured to be controlled by a control signal, an output voltage comprises providing, via a switching converter including a transformer and a switch configured to be controlled by a control signal, an output voltage suitable to drive a lighting element, and wherein the method reduces flickering of the lighting element due to false triggering of the OVP circuitry.

18. The method of claim 14, further comprising triggering the OVP circuitry of the controller circuitry in response to a valid OVP condition.
